(19) United States
(12) Patent Application Publication
(10) Pub. No.: US 2026/0249314 A1
(43) Pub. Date: Aug. 27, 2026

(54) AIR CAP FOR SPRAYING DEVICE

(71) Applicant: Yara International ASA, Oslo (NO)

(72) Inventors: Pieter VIDTS, Gentbrugge (BE); Arthur APPEL, Middelburg (NL); Ralf WESTERTERP, Hulst (NL)

(21) Appl. No.: 19/163,459

(22) PCT Filed: Apr. 24, 2024
(86) PCT No.: PCT/EP2024/061155

§ 371 Date: Sep. 9, 2025

(30) Foreign Application Priority Data
Apr. 24, 2023 (EP) 23169393.8

(51) Int. Cl. B05B 7/08

(52) U.S. Cl. CPC B05B 7/08

(57) ABSTRACT

An air cap for an atomization nozzle, wherein the air cap includes an open circular top end with a circular opening, an open circular bottom end parallel to the open circular top end, the open circular bottom end with a circular opening, and a circular wall extending from the open circular bottom end to the open circular top end. The circular wall has a thread extending from the bottom end of the circular wall, wherein the thread is positioned eccentric with respect to the opening of the open circular top end.

### FIELD OF THE DISCLOSURE

The present disclosure is related to the field of chemical engineering, in particular spraying devices.

### BACKGROUND INFORMATION

The manufacture of industrial products, such as fertilizers, requires different steps and processes. A process found in many manufacturing lines involves the spraying of a liquid composition as fine droplets. Such spraying process may be used to coat particles with a coating composition or to produce granules by spraying the liquid composition onto seed particles.

Granulation is a process wherein a liquid feed is sprayed inside a container comprising particles in movement. The liquid feed is divided into small droplets that come into contact with the particles comprised in the container and solidify on the particles. This mechanism leads to a growth of the particle size until the desired size is obtained.

Different sub-types of granulation exist, such as pan granulation, drum granulation, and fluidized bed granulation, but they all rely on the same principle described above.

Spraying the liquid feed as small droplets is usually done using spraying devices. Such devices continuously receive a liquid feed and inject via its nozzle this feed into the granulator in the form of droplets which size may vary.

Different types of nozzles can be used depending on factors, such as nature of the liquid feed, and the type of granulator. Examples of nozzles include pneumatic nozzles, and atomization nozzles.

Atomization nozzles are devices that require a feed of a compressed gas and a liquid feed. The atomization nozzles combine the gas feed and the liquid feed, such that liquid droplets exit the nozzle and enter the granulator. Spraying devices comprising atomization nozzles are assembled inside a granulator at the end of the pipes carrying the liquid feed and the gas feed.

### SUMMARY OF THE DISCLOSURE

A new air cap for a spraying device comprising an atomization nozzle has been designed. The new design allows to correct situations where the melt injection line and the air injection line of the atomization nozzle are not concentric, which may lead to a sub-optimal spraying pattern and granulation operations.

In a first aspect, the present disclosure provides an air cap for an atomization nozzle, wherein the air cap comprises a circular wall extending from an open circular bottom end having a first axis to an open circular top end having a second axis, wherein:
the open circular bottom end comprises a first circular opening;
the open circular top end comprises a second circular opening;
the open circular bottom end is arranged parallel to the open circular top end;
the circular wall has a height, which is defined by the distance between the open circular bottom end and the open circular top end, and a diameter, wherein the diameter of the circular wall varies along the height of the circular wall; and
the circular wall comprises a thread which extends from the open circular bottom end towards the open circular top end;
   and wherein the thread is positioned eccentric with respect to the second circular opening.

In another aspect, the present disclosure provides a granulator comprising a plurality of atomization nozzles, one or more conventional air cap(s), and one or more air cap(s) according to the present disclosure, wherein:
each conventional air cap comprises a circular wall defining an open bottom end comprising a circular opening, an open top end comprising a circular opening, the open top end being parallel to the open bottom end, and the opening of the open bottom end and the opening of the open top end being concentric; and the circular wall of the conventional air cap comprises a thread extending from its bottom end, the thread being concentric with the opening of the open top end of the conventional air cap; and
each atomization nozzle is surrounded by a conventional air cap or by an air cap according to any one of claims 1 to 8.

### BRIEF DESCRIPTION OF THE FIGURES

The following description of the figure of a specific embodiment of a system according to the present disclosure is only given by way of example and is not intended to limit the present explanation, its application or use. In the figure, identical reference numerals refer to the same or similar parts and features.

FIG. 1 is a view of a conventional air cap, wherein the thread of the circular wall is positioned concentric with the circular opening of the top end of the air cap.

FIG. 2 is a view of an air cap according to the present disclosure.

FIG. 3 is a view of another air cap according to the present disclosure.

FIG. 4 is a view of another air cap according to the present disclosure.

FIG. 5 is a view of another air cap according to the present disclosure.

FIG. 6 is a view of spraying nozzle, in particular an atomization nozzle, comprising an air cap according to the present disclosure.

### DETAILED DESCRIPTION OF THE DISCLOSURE

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

All references cited in this description are hereby deemed to be incorporated in their entirety by way of reference.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, in particular +/−10% or less, more in particular +/−5% or less, even more in particular +/−1% or less, and still more in particular +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

The recitation of numerical ranges by endpoints includes all numbers and fractions subsumed within that range, as well as the recited endpoints.

The expression “weight percent”, “% wt” or “weight %”, here and throughout the description unless otherwise defined, refers to the relative weight of the respective component based on the overall weight of the formulation.

For spraying devices comprising an atomization nozzle, a great variety of designs can be found, but they all follow the same general concept: the atomization nozzle is located at the end of a melt injection line which receives the liquid feed, and the spraying device also comprises an air cap which surrounds the melt injection line and is configured to receive a gas stream and guide the gas stream to generate liquid droplets.

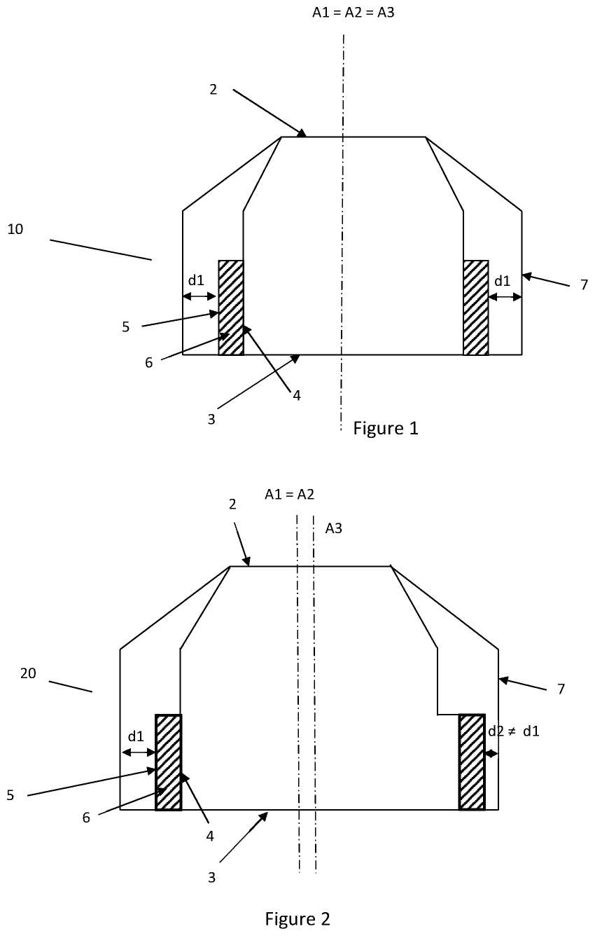

Air caps comprise a circular wall defining an open bottom end configured to receive a gas stream, and an open top end, configured to release the gas stream, with the circular wall extending from the open bottom end to the open top end. The bottom end is parallel to the top end, and the bottom end has a larger diameter than the top end. The diameter of the circular wall thus varies along the height of the circular wall and diminishes towards the top end. The opening of the top end and the opening of the bottom end are circular. In conventional air caps, the opening of the open bottom end and the opening of the open top end are concentric (see FIG. 1). The circular wall comprises an internal or external thread extending from its bottom such that it can be screwed onto the air injection line. The thread is concentric with the opening of the open top end.

The design and geometry of atomization nozzles can vary greatly, but one important feature for all atomization nozzles is that the opening of the air cap needs to be concentric with the melt injection line and the nozzle. This ensures a symmetrical spraying pattern of the liquid droplets, which is very important for the stability and reliability of the granulator operations.

In some cases, it was observed that it was difficult to install spraying devices comprising an atomization nozzle and an air cap, such that the opening of the air cap was concentric with the nozzle. In particular, this was the case when installing nozzles in a granulator wherein the ends of the pipes carrying the liquid feed and gas feed were not concentric. Typically, the pipe carrying the liquid feed to a nozzle is located inside the pipe carrying the gas feed, and both pipes should be concentric. However, it was found in some cases that such geometry was impossible to achieve perfectly: the two pipes entering the granulator are welded to the feed lines, and due to the length of the pipes, a very small error on the weld causes a deviation of 1 or 2 mm at the nozzle, which is enough to create an unsatisfactory spraying pattern. The result was that, after installation of the nozzle and the air cap, the opening of the air cap was not concentric with the nozzle and the nozzle created an unsymmetrical spraying pattern.

It has now been found that it is possible to correct that geometrical default by designing new air caps. In an air cap according to the present disclosure, the thread of the circular wall extending from the bottom of the air cap and the open top end of the air cap are not concentric. In other words, the axis of symmetry of the opening of the open top end does not coincide with the axis of symmetry of the thread.

The thread of the circular wall defines a circumference that is positioned eccentric with respect to the circular opening of the top end of the air cap.

As used herein, the bottom end of the air cap always refers to the end of the air cap with the larger diameter. The air cap is configured such that the gas stream enters the air cap from its bottom end and leaves the air cap at the top end.

In a first aspect, the present disclosure provides an air cap for an atomization nozzle, wherein the air cap comprises an open circular top end comprising a circular opening, an open circular bottom end parallel to the open circular top end, said open circular bottom end comprising a circular opening, and a circular wall extending from said open circular bottom end to said open circular top end, said circular wall comprising a thread extending from the bottom end of the circular wall, wherein said thread is positioned eccentric with respect to the opening of the open circular top end. Stated differently, the present disclosure provides an air cap for an atomization nozzle, wherein the air cap comprises a circular wall extending from an open circular bottom end having a first axis to an open circular top end having a second axis, wherein the open circular bottom end comprises a first circular opening and wherein the open circular top end comprises a second circular opening; wherein the open circular bottom end is arranged parallel to the open circular top end; wherein the circular wall comprises a thread which extends from the open circular bottom end towards the open circular top end, wherein the thread, particularly the circumference of the thread, is positioned eccentric with respect to the second circular opening.

The terms “concentric” and “eccentric” as used herein with respect to two features, particularly circular features, refers to the central axis of the first feature coinciding or not coinciding, respectively, with the central axis of the second feature. In particular, the thread, having a circular circumference and having a third axis, is positioned eccentric with respect to the second circular opening when the third axis does not coincide or is not superposed with the second axis of the second circular opening. More in particular, the circular wall further has a diameter and a height, with the height defined by the distance between the open circular bottom end and the open circular top end, wherein the diameter of the circular wall varies along the height of the circular wall.

The air cap according to the present disclosure is configured to be screwed and welded onto the threaded end of an air injection line to ensure that the air cap does not move during the operation of the granulator. The fact that the thread of the circular wall and the opening of the open circular top end of the air cap are eccentric ensures that it is possible to find a position along the thread wherein the opening of the open circular top end of the air cap and the nozzle are concentric, ensuring an optimum spraying pattern.

The thread may be internal or external to the circular wall. Stated differently, the thread may be positioned on an internal surface or on an external surface of the circular wall. The thread extends from the open circular bottom end of the cap towards the open circular top end.

In some embodiments, an air cap according to the present disclosure can be similar to a conventional air cap in that the opening of the open bottom end of the circular wall and the opening of the open top end of the circular wall are concentric, but the thread of the circular wall is eccentric with the opening of the open top end.

In some embodiments, the opening of the open circular top end and the opening of the open circular bottom end are eccentric.

In some embodiments, the opening of the open circular top end and the opening of the open circular bottom end are concentric.

In some embodiments, the open circular top end and the open circular bottom end are eccentric.

In some embodiments, the opening of the open circular top end and the opening of the open circular bottom end are concentric.

In some embodiments, the opening of the open bottom end of the circular wall and the opening of the open top end of the circular wall are eccentric, and the thread is concentric with the opening of the open bottom end and eccentric with the opening of the open top end.

In some embodiments, the distance between the third axis of the thread and the second axis of the open circular top end is from 0.5 to 5.0 mm. In industrial granulators, it was often observed that the non-alignment of the air feed and melt feed to the atomization nozzle was only off by a few millimeters. An air cap according to the present disclosure wherein the distance between its second and third central axis is from 0.5 and 5.0 mm was enough to compensate this non-alignment.

In some embodiments, the diameter of the bottom end of the air cap is from 40 to 60 mm. The diameter of the air cap depends on the dimensions of the granulator and the dimensions of atomization nozzles comprised in the granulator.

In some embodiments, the diameter of the top end of the air cap is from 20 to 30 mm.

In some embodiments, the air cap is made of metal, in particular of stainless steel, such as 304 or 316 stainless steel. In some embodiments, the liquid injected by the nozzles is corrosive, and the air cap must be made in a material resistant to corrosion.

In some embodiments, the height of the thread is from 20 to 30 mm.

In another aspect, the present disclosure provides an assembly comprising a spraying nozzle and an air cap according to the first aspect of the present disclosure. The spraying nozzle and the air cap are assembled such that the axis of the open circular top end of the air cap is concentric with the nozzle. This ensures that the spraying pattern of the nozzle is circular and centered on the nozzle.

In some embodiments, the spraying nozzle is placed directly above and connected to a first circular pipe configured to direct a liquid composition, for example a fertilizer melt, to be sprayed in a device, such as a granulator. The first circular pipe is surrounded by a second circular pipe that is configured to direct a gas, in particular compressed air. The first circular pipe has a fourth axis that superposes with the first and second axis of the air cap. The second circular pipe has a fifth axis that does not superpose with the fourth axis. The top end of the second circular pipe is connected to a thread on which the air cap is screwed on, such that the third axis of the thread superposes with the fifth axis of the second circular pipe.

In some embodiments, the spraying nozzle is an atomization nozzle.

In another aspect, the present disclosure provides a granulator comprising a plurality of atomization nozzles, one or more conventional air cap(s), and one or more air cap(s) according to the present disclosure, wherein:
the conventional air cap, particularly each conventional air cap, comprises a circular wall defining an open bottom end comprising a circular opening, an open top end comprising a circular opening, the open top end being parallel to the open bottom end, and the opening of the open bottom end and the opening of the open top end being concentric, wherein the circular wall of the conventional air cap further comprises a thread extending from its bottom end, the thread being concentric with the opening of the open top end of the conventional air cap; and
each atomization nozzle is surrounded by a conventional air cap or an air ap according to the first aspect of the present disclosure.

In some embodiments, the granulator is a fluidized bed granulator, a drum granulator, or a pan granulator.

A granulator, such as a fluidized bed granulator may contain from 10 to 500 atomization nozzles. The number of nozzles depends on factors such as the size of the granulator and the desired production rate. It may be that only a fraction of the atomization nozzles requires an air cap according to the present disclosure while the other fraction can be equipped with conventional air caps, wherein the opening of the open circular bottom end of a conventional air cap is concentric with the opening of the open circular top end of a conventional air cap.

FIG. 1 is a view of a conventional air cap 10 cut on its diameter: the air cap 10 comprises an open circular bottom end 3, an open top circular end 2 parallel and the opening of the open circular bottom end 3 is concentric with the opening of the open circular top end 2. The open circular bottom end 3 is characterized by a first central axis A1, and the open circular top end 2 is characterized by a second central axis A2. Since the two ends are concentric, the two axis A1 and A2 superpose. The circular wall 7 extending from the bottom end 3 to the top end 2 of the air cap 10 comprises an internal thread 6 extending from the open circular bottom end 3 towards the open circular top end 2. The thread has a central thread axis A3, which superposes with the first and second central axes (A1, A2). Line 4 represents the crest of thread 6, and line 5 the root of thread 6.

FIG. 2 is a view of an air cap 20 according to the present disclosure cut on its diameter: the air cap 20 comprises an open circular bottom end 3, an open top circular end 2 parallel with the open circular bottom end 3. The open circular bottom end 3 is characterized by a first central axis A1, and the open circular top end 3 is characterized by a second central axis A2. The open circular bottom end 3 and the open top circular end 2 are concentric, so the two axis A1 and A2 superpose. The circular wall 7 extending from the bottom end 3 to the top end 2 of the air cap 20 comprises an internal thread 6, and the internal thread 6 is not concentric with the open circular bottom end 3 and the opening of the open top circular end 2, as shown on FIG. 2 by the fact that the distance d1 from the exterior side of the wall 7 to the root 5 of the thread 6 on one side is different than the opposite distance d2 from the exterior side of the wall 7 to the root of the thread 6. Said otherwise, the thread 6 has a central thread axis A3, which does not superpose with the first and second central axis (A1, A2).

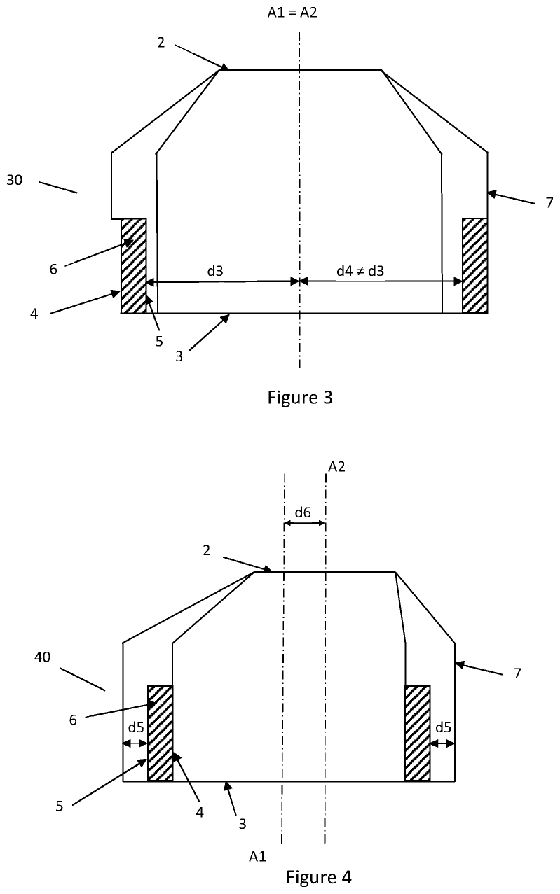

FIG. 3 is a view of an air cap 30 according to the present disclosure cut on its diameter: the air cap 30 comprises an open circular bottom end 3, an open top circular end 2 parallel with the open circular bottom end 3. The open circular bottom end 3 is characterized by a first central axis A1, and the open circular top end 3 is characterized by a second central axis A2. The open circular bottom end 3 and the open top circular end 2 are concentric, so the two axis A1 and A2 superpose. The circular wall 7 extending from the bottom end 3 to the top end 2 of the air cap 20 comprises an external thread 6, and the external thread 6 is not concentric with the open circular bottom end 3 and the opening of the open top circular end 2, as shown on FIG. 3 by the fact that the distance d3 from the central axis A1 of the open circular bottom end 3 to the root 5 of the thread 6 on one side is different than the opposite distance d4 from the central axis A1 of the open circular bottom end 3 to the root of the thread 6.

FIG. 4 is a view of an air cap 40 according to the present disclosure cut on its diameter: the air cap 40 comprises an open circular bottom end 3, an open top circular end 2 parallel with the open circular bottom end 3. The open circular bottom end 3 is characterized by a first central axis A1, and the open circular top end 3 is characterized by a second central axis A2. The open circular bottom end 3 and the open top circular end 2 are not concentric, so the two axis A1 and A2 do not superpose and are separated by a distance d6. The circular wall 7 extending from the bottom end 3 to the top end 2 of the air cap 40 comprises an internal thread 6, and the internal thread 6 is concentric with the open circular bottom end 3, but not with the open top circular end 2, as shown on FIG. 4 by the fact that the distance d5 from the exterior side of the wall 7 to the root 5 of the thread 6 on one side is equal to the opposite distance d5 from the exterior side of the wall 7 to the root of the thread 6.

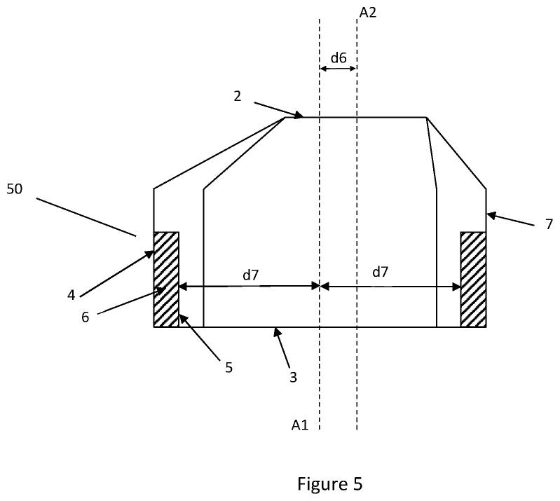

FIG. 5 is a view of an air cap 50 according to the present disclosure cut on its diameter: the air cap 50 comprises an open circular bottom end 3, an open top circular end 2 parallel with the open circular bottom end 3. The open circular bottom end 3 is characterized by a first central axis A1, and the open circular top end 3 is characterized by a second central axis A2. The open circular bottom end 3 and the open top circular end 2 are not concentric, so the two axis A1 and A2 do not superpose and are separated by a distance d8. The circular wall 7 extending from the bottom end 3 to the top end 2 of the air cap 50 comprises an external thread 6, and the external thread 6 is concentric with the open circular bottom end 3, but not with the open top circular end 2, as shown on FIG. 4 by the fact that the distance d7 from the first central axis A1 to the root 5 of the thread 6 on one side is equal to the opposite distance d7 from the first central axis A1 to the root of the thread 6.

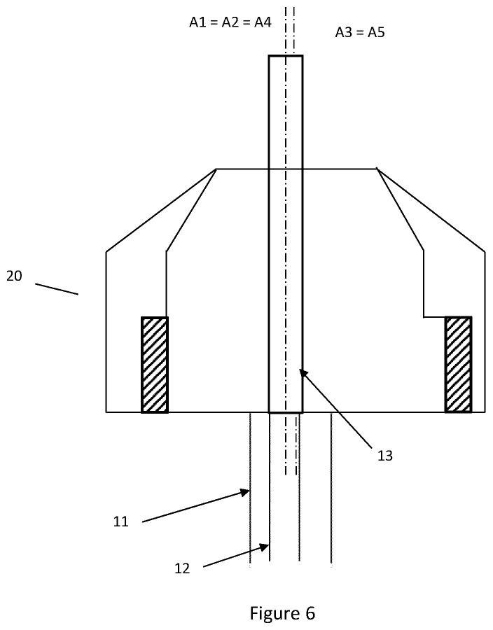

FIG. 6 is a view of the air cap 20 from FIG. 2 assembled with an atomization nozzle 13. The nozzle 13 is placed directly above and connected to a first circular pipe 12 configured to direct a liquid composition, for example a fertilizer melt, to be sprayed in a device. The first circular pipe 12 is surrounded by a second circular pipe 11 that is configured to direct a gas, in particular compressed air. The first circular pipe 12 has a fourth axis A4 that superposes with the first and second axis (A1, A2). The second circular pipe 11 has a fifth axis A5 that does not superpose with the fourth axis A4. The top end of the second circular pipe 11 is connected to a thread on which the air cap 20 is screwed on, such that the third axis of the thread A3 superposes with the fifth axis A5 of the second circular pipe A3.

1. An air cap for an atomization nozzle, wherein the air cap comprises:
a circular wall extending from an open circular bottom end having a first axis to an open circular top end having a second axis, wherein;
wherein the open circular bottom end comprises a first circular opening;
wherein the open circular top end comprises a second circular opening;
wherein the open circular bottom end is arranged parallel to the open circular top end;
wherein the circular wall has a height defined by distance between the open circular bottom end and the open circular top end;
the wherein a diameter of the circular wall varies along the height of the circular wall; and
wherein the circular wall comprises a thread which extends from the open circular bottom end towards the open circular top end; and
wherein the thread is positioned eccentric with respect to the second circular opening.

2. The air cap according to claim 1, wherein the open circular top end and the open circular bottom end are concentric.

3. The air cap according to claim 1, wherein the open circular top end and the open circular bottom end are eccentric.

4. The air cap according to claim 1, wherein the thread is internal or external to the circular wall.

5. The air cap according to claim 1, wherein the thread has a third axis, and a distance between the third axis and the second axis of the open circular top end is from 1.0 to 5.0 mm.

6. The air cap according to claim 5, wherein a diameter of the open circular bottom end is from 40 to 60 mm.

7. The air cap according to claim 6, wherein a diameter of the open circular top end is from 20 to 30 mm.

8. The air cap according to claim 7, wherein a height of the thread is from 20 to 30 mm.

9. A granulator comprising a plurality of atomization nozzles, one or more conventional air caps, and one or more air caps according to claim 1, wherein:
each of the one or more conventional air caps comprises a circular wall defining an open bottom end comprising a circular opening, an open top end comprising a circular opening, the open top end being parallel to the open bottom end, and the opening of the open bottom end and the opening of the open top end being concentric; and the circular wall of the conventional air cap comprises a thread extending from its bottom end, the thread being concentric with the opening of the open top end of the conventional air cap; and
each of the plurality of atomization nozzles is surrounded by a one of the one or more conventional air caps or by one of the one or more air caps.

10. The granulator according to claim 9, wherein the granulator is a fluidized bed granulator.

11. The air cap according to claim 1, wherein a diameter of the open circular bottom end is from 40 to 60 mm.

12. The air cap according to claim 1, wherein a diameter of the open circular top end is from 20 to 30 mm.

13. The air cap according to claim 1, wherein a height of the thread is from 20 to 30 mm.
